(19) United States
(12) Patent Application Publication
(10) Pub. No.: US 2006/0245384 A1
(43) Pub. Date: Nov. 2, 2006

(54) Method and apparatus for transmitting data

(76) Inventors: Anup K. Talukdar, Schaumburg, IL (US); Brian K. Classon, Palatine, IL (US); Mark C. Cudak, Rolling Meadows, IL (US); Philippe J. Sartori, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/120,116

(22) Filed: May 2, 2005

(51) Int. Cl. H04B 7/00

(52) U.S. Cl. 370/310; 370/389; 370/465

(57) ABSTRACT

Received data packets are channel-encoded prior to fragmentation so that large data packets, which would not otherwise fit within the available frame resources, are transmitted by fragmenting the channel-encoded physical layer packet. Hybrid Automatic Repeat Request (H-ARQ) is then utilized to ensure reliability.

### FIELD OF THE INVENTION

The present invention relates generally to data transmission and in particular, to a method for transmitting data within a communication system.

### BACKGROUND OF THE INVENTION

The transmission of large data packets within a communication system usually requires that the large data packets be fragmented in order to fit into a physical over-the-air radio frame. More particularly, to deliver larger sized packets, the general technique used for next-generation cellular systems as well as broadband wireless access systems, such as IEEE 802.16 systems, is to fragment packets at the Medium Access Control (MAC) layer. Large packets are split into smaller segments (fixed size or variable size) before encoding, each of which can fit within the available radio frame resources when coded using a modulation and coding scheme (MCS). After receiving all the fragments of a packet correctly, the receiver assembles them into the original packets. In this scheme, each of the fragments is treated as an independent entity by the coding and decoding components of the system.

FIG. 1 illustrates prior-art MAC fragmentation process. Data packets (such as internet protocol (IP) packets) enter the system from the network layer and are processed by a fragmentation module within the MAC layer. The fragmentation module fragments the IP packets into multiple MAC protocol data units (PDUs), each small enough to fit into a radio frame (F1, F2, . . . etc.). The MAC PDU forms the reliability unit (RU) for these systems and includes means of error detection such as cyclic redundancy check (CRC) and also a MAC header. The MAC PDUs are then encoded via a channel coder to form a codeword and transmitted as part of a physical layer frame. Once received, these codewords are decoded by a channel decoder and then reassembled by the re-assembly module in order to deliver complete data packets to the network layer.

MAC-layer fragmentation complicates the protocol stack, resulting in higher overall latency for the end to end packet transmission. The transmitter is required to fragment a packet prior to channel encoding and often before multiplexing data with other users. To ensure proper multiplexing, a transmitter will often have to create fragments which are much smaller than the capacity of the physical frame. These small fragments require a significant increase in the overhead since each fragment will require its own PDU header. Moreover, MAC-layer fragmentation is not optimal from a channel coding standpoint since the channel encoding is done with a relatively small information frame size, resulting in transmission inefficiencies. Therefore, a need exists for a method and apparatus for transmitting data that solves the above-mentioned problems.

### BRIEF DESCRIPTION OF THE DRAWINGS

FIG. 1 illustrates prior-art fragmentation.

FIG. 2 illustrates fragmentation in accordance with an embodiment of the present invention.

FIG. 3 is a block diagram of a transmitter and receiver.

FIG. 4 and FIG. 5 illustrate transmission of IP packets belonging to both high-SNR and low-SNR users in a generic air-interface architecture.

FIG. 6 shows the transmission of two IP packets, IP1 and IP2, over a multi-carrier system.

FIG. 7 shows the application of the physical layer fragmentation scheme in the frequency selective allocation scheme.

FIG. 8 and FIG. 9 show the exchange of messages between the transmitter and receiver of FIG. 3.

FIG. 10 is a flow chart showing operation of the transmitter of FIG. 3.

FIG. 11 is a flow chart showing operation of the receiver of FIG. 3.

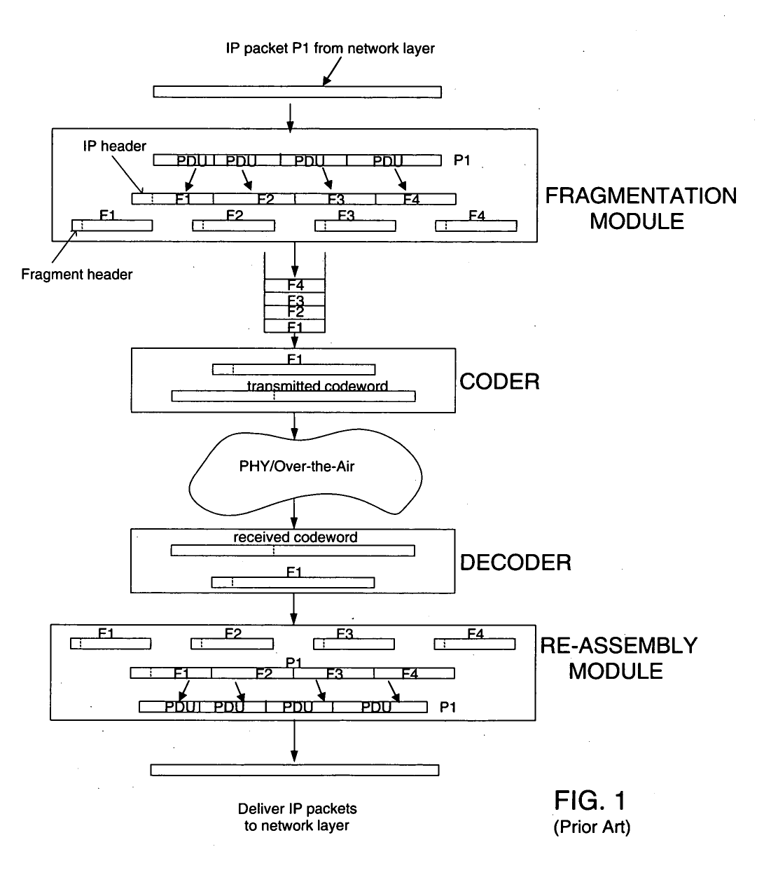

### DETAILED DESCRIPTION OF THE DRAWINGS

In order to address the above-mentioned need, a method and apparatus for transmitting data is provided herein. In accordance with a preferred embodiment of the present invention, received data packets are channel-encoded prior to fragmentation. In other words, large data packets, which would not otherwise fit within the available frame resources, are transmitted by fragmenting the channel-encoded physical layer packet. This is in sharp contrast to the MAC layer fragmentation scheme where, data packets are fragmented (prior to channel encoding) into information segments of size which will fit within the available time-frequency resources after channel encoding. Hybrid Automatic Repeat Request (H-ARQ) is then utilized to ensure reliability.

By eliminating MAC fragmentation and using fast physical layer H-ARQ to provide packet reliability, the latency and overhead of a traditional MAC layer can be avoided. Additionally, large IP packets can be directly sent over the air and a high degree of frame occupancy can be achieved. The above technique virtually eliminates frame boundaries providing lower latency and overhead reduction for IP-on-the-air even for mobiles in poor channel conditions or with narrow channel allocations.

The present invention encompasses a method for transmitting data. The method comprises the steps of receiving a reliability unit comprising a data packet, encoding the reliability unit to produce a codeword, fragmenting the codeword into a plurality of fragments, placing the plurality of fragments into a plurality of over-the-air frames, and transmitting the plurality of over-the-air frames.

The present invention additionally encompasses a method for receiving data. The method comprises the steps of receiving a plurality of over-the-air frames, extracting a plurality of codeword fragments from the over-the-air frames, assembling the plurality of codeword fragments into a codeword, and decoding the codeword to produce a reliability unit.

The present invention additionally encompasses an apparatus comprising an encoder receiving a reliability unit comprising a data packet and encoding the reliability unit to produce a codeword, a fragmentation unit fragmenting the codeword unit into a plurality of fragments, and a transmitter placing the plurality of fragments into a plurality of over-the-air frames and transmitting the plurality of over-the-air frames.

The present invention additionally encompasses an apparatus comprising a receiver receiving a plurality of over-the-air frames and extracting a plurality of codeword fragments from the over-the-air frames, a re-assembly unit assembling the plurality of codeword fragments into a codeword, and a decoder decoding the codeword to produce a reliability unit.

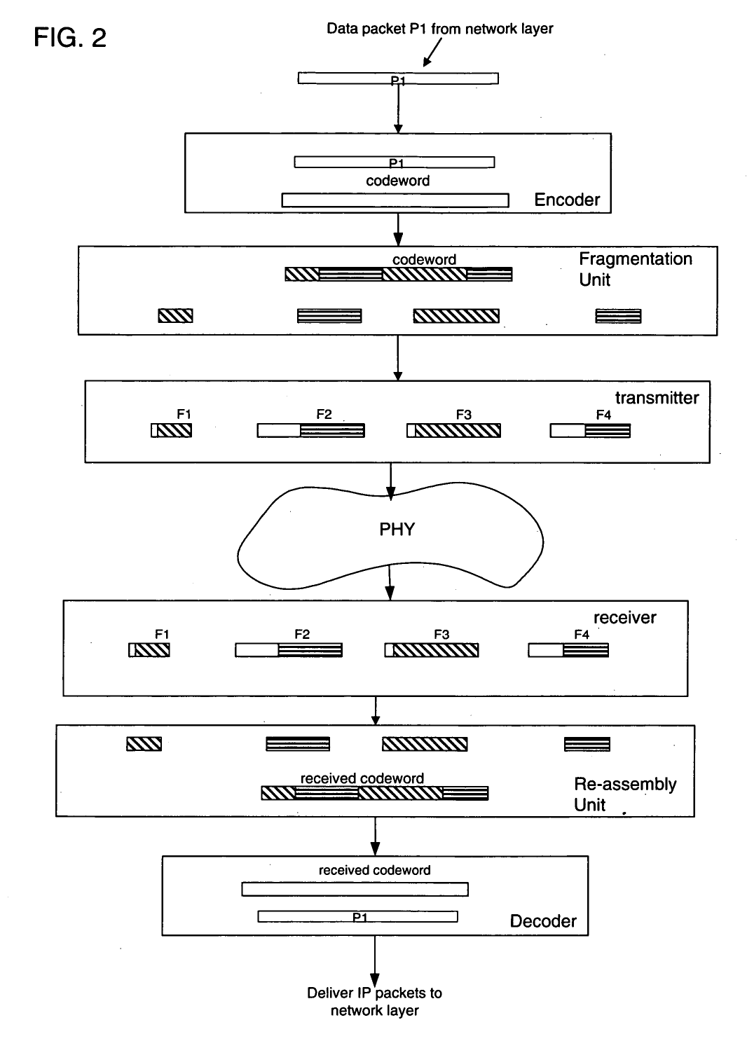

Turning now to the drawings, wherein like numerals designate like components, FIG. 2 illustrates fragmentation in accordance with an embodiment of the present invention. As shown, data (e.g., IP, UDP, . . . , etc.) packets (P1) enter the system from the network layer forming a Reliability Unit (RU). An RU is composed of one or more data packets (such as IP packets) with an appended header. The header may contain many types of information, as is known in the art, and typically comprises a QoS indication to designate the QoS level and packet number used to insure in order delivery. The QoS level may be communicated in a number of ways. For example, IEEE 802.16 uses Connection Identifiers (CID) which implicitly identify the QoS of the flow. Many other parameters may also be included in the MAC header for the purpose of further multiplexing and fragmentation of MAC level PDUs. For example, a length indication would allow the MAC to packet multiple IP packet within RU with each IP packet having a separate header. The RU is then encoded by the physical layer into a codeword. Overhead for error detection such as CRC may be added to the RU. The codeword is then fragmented to match the available space in the current radio frame and then transmitted. More particularly, the fragmentation unit analyzes the available space within each frame (provided by the transmitter), and fragments the codeword such that the frames are maximally filled. As is evident, the codeword need not be divided into equal segments. Since the codeword obtained with physical layer fragmentation is larger than a codeword obtained with MAC-layer fragmentation, better channel coding performance can be achieved with modem coding schemes such as convolutional turbo-codes or low density parity check codes. The fragments are placed into a plurality of over-the-air frames and transmitted on a physical channel. yyyy

Once each codeword fragment is received, the collection of received codeword fragments is partially re-assembled prior to decoding by the physical layer. Due to the nature of Hybrid ARQ, a complete un-fragmented RU may be delivered to the MAC layer even if all codeword fragments have not been received as long as the channel decoder is able to decode the partially received codeword.

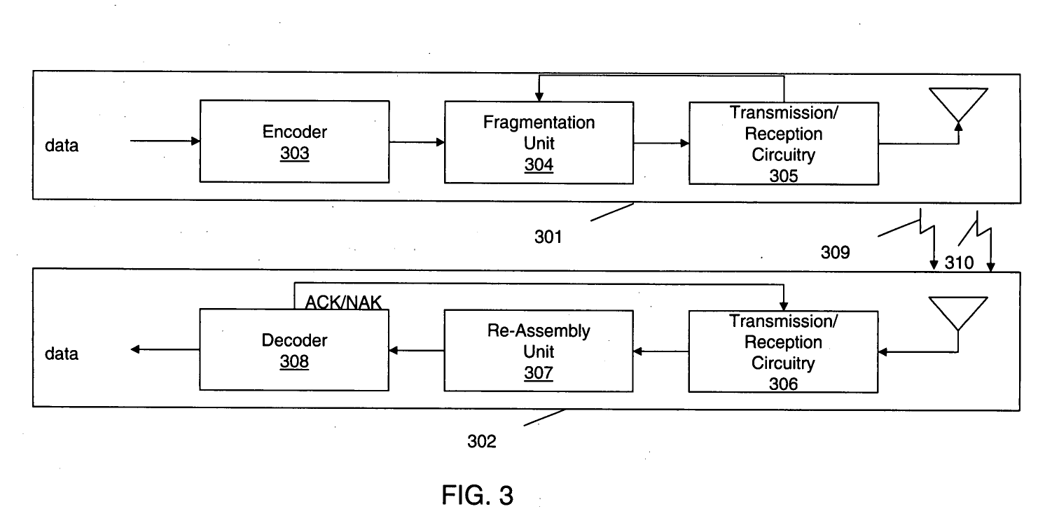

FIG. 3 is a block diagram of a transmitter and receiver. As shown, transmitter 301 comprises channel encoder 303, fragmentation unit 304, and transceiver (transmission/reception) circuitry 305, while receiver 302 comprises transceiver circuitry 306, re-assembly unit 307, and channel decoder 308. Transceiver circuitry 305 and 306 comprises common circuitry known in the art for communication utilizing well known communication protocols (e.g., CDMA, TDMA, GSM, WCDMA, OFDM, . . . , etc.), and serve as means for transmitting and receiving messages. Fragmentation unit 304 and re-assembly unit 307 comprise logic circuitry such as a microprocessor controller that provides means for fragmenting and re- assembling codewords . Finally, encoder 303 and decoder 308 preferably comprise well known channel encoders for encoding RUs and decoding codewords. For example, channel encoder 303 and channel decoder 308 may comprise a convolutional turbo encoder and decoder, respectively, utilized to encode RUs and decode codewords via a convolutional turbo coding scheme. Other channel coding schemes such as low density parity check codes or convolutional codes may be used as well.

Channel encoder 303 constructs a RU by retrieving data packets from a user's queue. An RU is composed of one or more data packets (such as IP packets) with an appended header. The RU may be up to the maximum transmit unit (MTU) size. No MAC fragmentation is assumed or required. The number of packets in an RU may be determined by factors such as the available number of packets in the queue and their sizes. In addition, the number packets in an RU is subject to the constraints of minimum and maximum sizes of an RU. The selected MCS is based on a MCS selection technique which is a known process in the art and may be based on link error prediction techniques such as the Exponential Effective Signal Mapping technique or by targeting a target frame error rate of 1% on the first transmission. After constructing the RU, the channel encoder creates a codeword by modulating and encoding the RU using the selected MCS,

The number of symbols, denoted as S, required for transmission of a codeword can be computed as:

$$S = \frac{N * 8}{MCR}$$

where N is the size of the RU in bytes, MCR is the Modulation Coding Rate (in bits/symbol).

In general, a radio frame can only carry a finite number of data symbols. For example, in an OFDM system the amount of information that can be carried in a frame is determined by number of factors including the frame duration, the occupied bandwidth, the sub-carrier spacing, cyclic prefix duration and the number of pilot symbols. As a result, the available number of symbols within a frame is often less than the total number of symbols necessary to send a single codeword. Therefore, the encoded codeword must be fragmented to fit the available space.

The step-by-step process of this physical layer fragmentation scheme at transmitter 301 is as follows:

1. Channel encoder 303 encodes a packet of a size up to the Maximum Transmission Unit (MTU) size. In practice, an RU which consists of one or more data/IP packets is directly sent to channel encoder 303. After channel encoding, the encoded RU or codeword is referred to as C.

2. If the codeword C will not fit in current frame, fragmentation unit 304 fragments C into C₁, C₂. The amount of free resources for C is dependent on the codeword fragments from other users. It also may depend on the particular resource allocation scheme, e.g. in a multi-carrier system transmissions to/from a user may be done only over selected number of sub-carriers. The resource allocation process can be a joint optimization process between all users. However, an advantage of this physical layer fragmentation scheme is that it allows simple and efficient scheduling such that the joint optimization would likely not be needed.

3. Transmission circuitry 305 transmits the codeword fragment C₁ on a frame. Note that if some resources remain unoccupied after the scheduling of C₁, this step-by-step process can be reapplied for other packets until all the free space is consumed. 4. The remaining C₂ is sent on a subsequent frame. Optionally, C₂ does not need to be sent if a prior transmission is successfully received and an early termination ACK is received by receiver 301.

As is evident, it is possible of course to fragment one packet in as many pieces as desired. This feature is useful for users with a weak radio link. Also, it is possible to apply this process iteratively: if ^{C}₂ does not fit in a frame, it can be divided into two fragments, ^{C}^{⁴⁰} ₁ and ^{C}^{⁴⁰} ₂ 2 so that ^{C}^{²}^{=C}^{⁴⁰} ₁^{∪C}^{^{′}}₂. ^{C}^{^{′}}₂ would then be transmitted on a following frame.

The following optional method can be implemented at the transmitter 301 so that receiver 302 can reduce feedback overhead and save valuable radio resources. 1. If the set of fragments of C transmitted so far contain enough information bits (including CRC bits) so that a decoding attempt has a reasonable chance of success, the transmitter 301 allocates radio resources for the feedback from the mobile receiver. 2. Receiver 302 estimates the minimum size of the Physical Layer Packet which will contain the systematic bits and the CRC. This information can be derived from the assignment message sent by the transmitter 301. 3. ACK/NACK suppression: After receiving a fragment of the physical layer packet, receiver 302 determines if it has received all systematic bits and the CRC. If so, it attempts to decode the received codeword and sends an ACK/NACK depending on the outcome of the decoding. If it has not yet received all of the systematic bits and CRC, receiver 302 does not send any feedback. Alternatively, transmitter 301 can explicitly instruct receiver 302 to suppress the ACK/NACK when sending the allocation for the physical packet fragment.

In the above algorithm, it was assumed that transmitter 301 is the base station in the context of a cellular communication system and the receiver 302 is the remote unit. However, the general scheme of physical layer fragmentation can be applied also when the remote unit is the transmitter and the base station is the receiver, or even in systems such as ad-hoc networks.

As discussed, fragmentation unit 304 determines the available resources (in number of symbols) in the current frame. This information is fed back from transmission circuitry 305. Note that fragments of codewords, may exist whose transmission began in some earlier frame. These fragments may be transmitted with higher priority than new packets from the queue. If no such fragments are pending for transmission or if the transmitter deems profitable to transmit fragments of not yet channel encoded RUs (for instance, to take advantage of a multi user diversity gain), a new RU is constructed and encoded from the IP packets in the queue (as described above). Fragmentation unit 304 determines the number of symbols required for transmission of the codeword based on the modulation scheme to be used. The entire codeword is transmitted if it fits into the available space on the frame. Otherwise, a codeword fragment is created which fits into the available space on the frame and transmitted; the remaining codeword fragment will be transmitted in a future frame when the user is scheduled again.

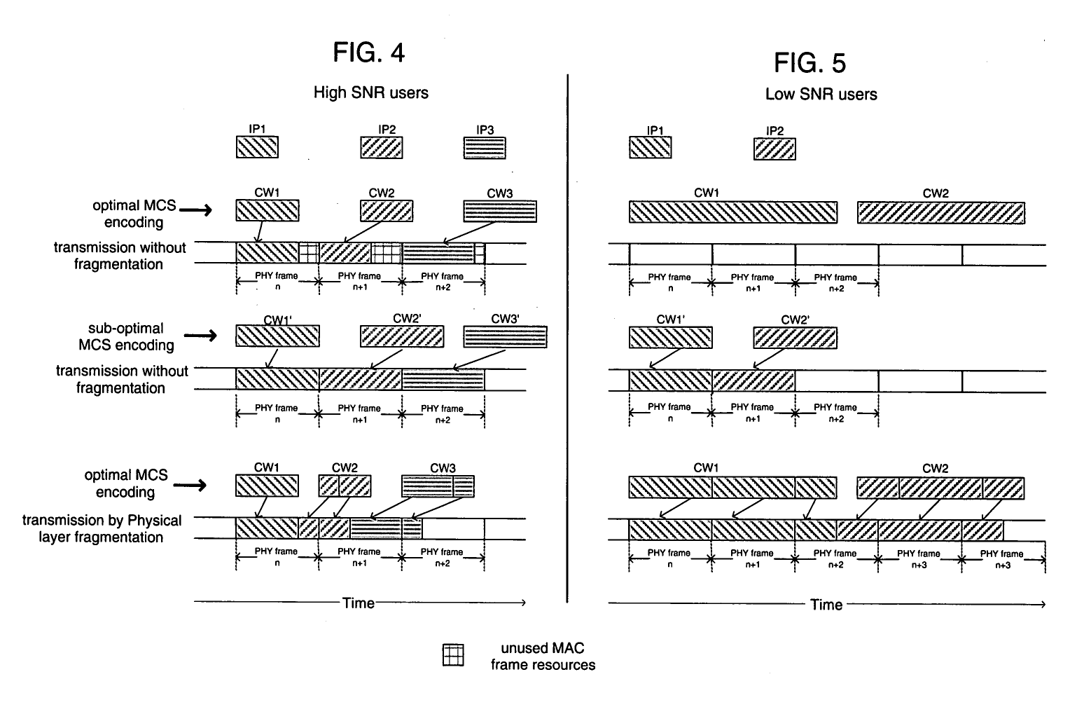

FIG. 4 and FIG. 5 illustrate transmission of packets (in this case IP packets) belonging to both high-SNR and low-SNR users in a generic air-interface architecture, respectively. Also, the benefits of using physical layer fragmentation over the cases when no fragmentation is used and when frame-filling technique is used are illustrated. For the high-SNR case (FIG. 4), three RUs are created from three IP packets, IP1, IP2 and IP3, which may belong to the same user or to different users. The sizes of each of these packets, CW1, CW2 and CW3, after being modulated and channel encoded with the selected MCS are less than the frame size. After allocating physical resources in an empty frame to each of these codewords, some amount of physical resources remain unused, because none of the other codewords could completely fit within the remaining space. Thus 100% frame utilization could not be achieved and these unused resources are most likely to be wasted. In the frame-filling scheme, sub-optimal MCSs (lower than the optimal MCS values) are used to generate the codewords CW1′, CW2′and CW3′, such that each of them occupy an entire frame. By using physical layer fragmentation scheme, the selected MCS will be used to encode the packets. The selected MCS may be optimal or substantially optimal based on some factors such as the target frame error rate or the selected aggressiveness factor. After allocating resources for CW1 in frame n, the remaining available resources are used to transmit a fragment of CW2. The remaining part of CW2 is then transmitted in frame n+1. Similarly, CW3 is divided into two fragments: the 1^{st} fragment is transmitted over the remaining available free resources of frame n+1 and the 2_{nd} fragment is transmitted in frame n+2. The rest of the resources in frame n+2 can be used to transmit next packets. Note that for clarity in FIG. 4, the selected MCS and therefore codeword sizes are shown for three packets. However, in practice the selected MCS for each packet and therefore the size of each associated codeword should be determined just prior to transmission in order to employ the latest channel information. Therefore the size of CW1 and CW2 would be determined just prior to frame n, while the size of CW3 need not be determined until one frame later.

For low-SNR users, transmission of two IP packets IP1 and IP2 are shown in FIG. 5. The codewords generated by using the selected MCS of the users, CW1 and CW2, are too large to fit in a single physical layer frame resources. Thus, these packets cannot be transmitted when no fragmentation scheme is used. Using sub- selected MCS values (higher than the selected MCS), the packets can be encoded to generate the codewords CWI′ and CW2′, each of which are equal to the frame size. However, the success probabilities of these transmissions can be very low. When physical layer fragmentation is used, selected MCS encoding can be used to transmit these packets over multiple frames as shown in the figure. Note that for clarity in FIG. 5, the selected MCS and therefore codeword sizes are shown for two packets. However, in practice the selected MCS for each packet and therefore the size of each associated codeword should be determined just prior to transmission in order to employ the latest channel information. Therefore the size of CW1 would be determined just prior to frame n, while the size of CW2 need not be determined until two frames later.

The physical layer fragmentation scheme in a multi-carrier system and employing turbo codes for forward error correction (FEC) works as follows. The channel encoder 303 generates the codeword consisting of the systematic bits (including the CRC) followed by the parity bits by encoding an RU, containing one or more packets with the selected MCS. The encoded RU is then mapped to modulated symbols for transmission. The time-frequency resources of the physical layer frame are organized as blocks of Resource Elements (REs), each RE consisting of a fixed number of symbols. The encoded IP packet is also divided into blocks of symbols, each of which can fit into an RE of the frame. The available resources for transmission of a user's packets depend on the resource allocation policy being used. For frequency-diversity allocation scheme, the allocated REs for transmission of a user's packet are dispersed over the complete range of the bandwidth. For frequency- selective allocation scheme, the entire bandwidth is divided into a number of bands; for each band a user is selected to transmit. When the available frame resources are not sufficient to transmit the complete codeword, fragments are created beginning with the systematic bits, and then followed by the parity bits.

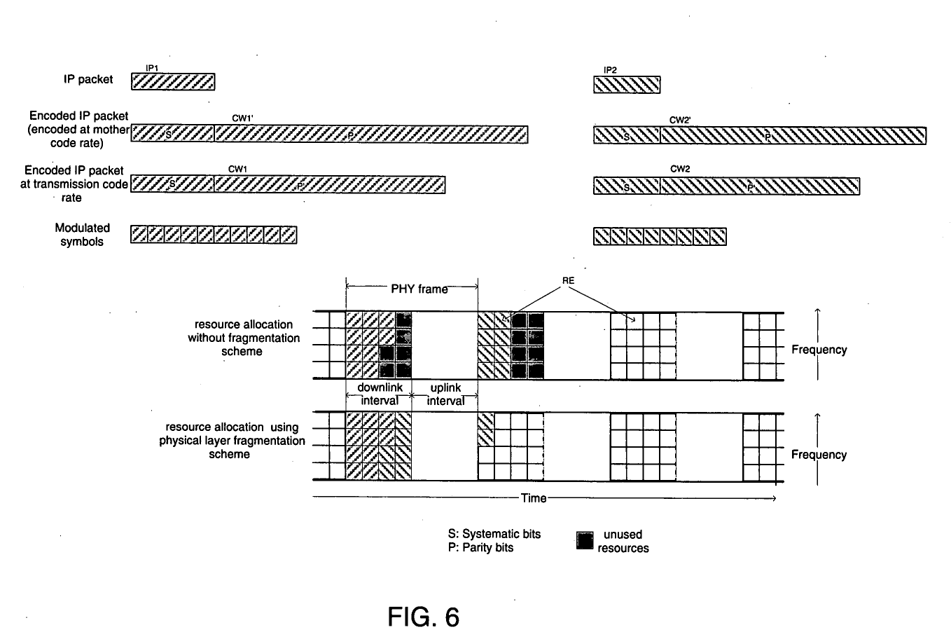

In FIG. 6, the transmission of two IP packets, IP1 and IP2, over a multi-carrier system is shown. IP1 and IP2 form two independent reliability units. Based on the selected MCS, the number of symbols required to transmit the RUs are determined. IP1 and IP2 are channel encoded to form CW1 and CW2. In this example, the downlink frame interval has enough resources to transmit each of these two RUs. However without using any fragmentation scheme, 100% utilization of the frame resources cannot be achieved. Using physical layer fragmentation technique, the available REs after allocating CW1 in frame n can be used to transmit a fragment of CW2. The rest of CW2 can be transmitted in the frame n+1.

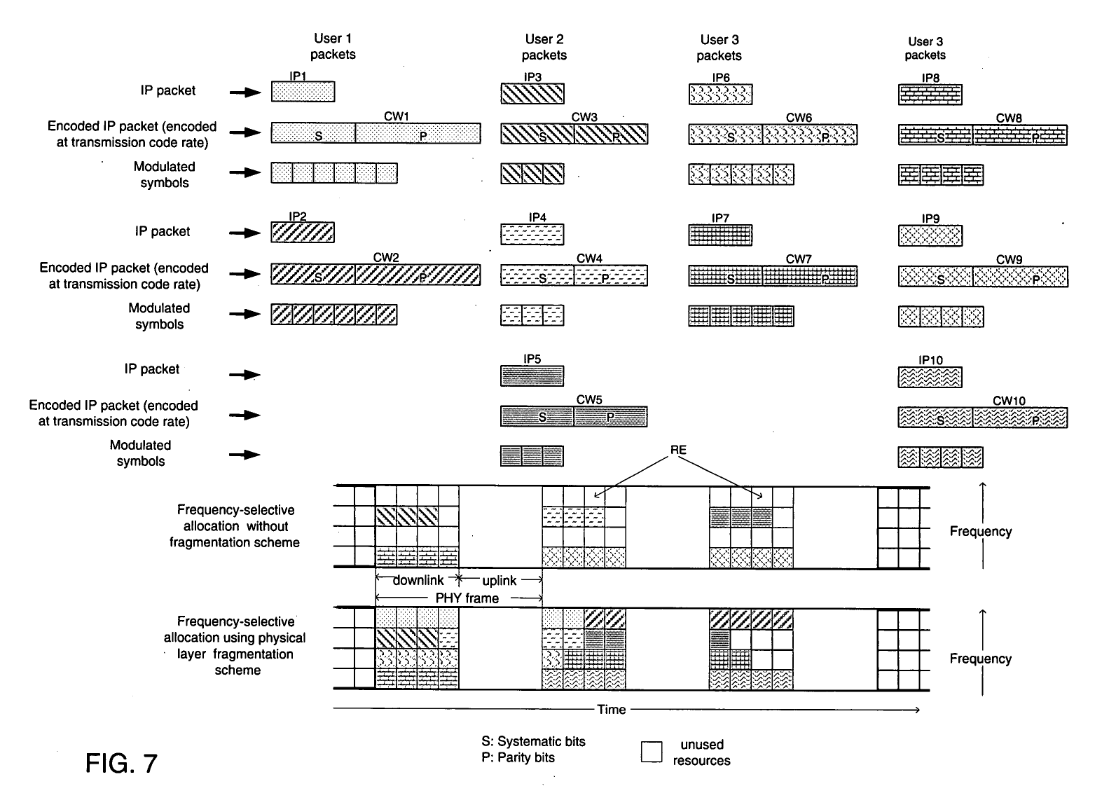

In FIG. 7, the application of the physical layer fragmentation scheme is shown in the frequency selective allocation scheme. In the figure, the total frequency bandwidth is divided into several frequency bands. There are four users with packets queued for transmission. Based on their channel condition, the users are selected to transmit their data on the frequency bands as indicated in the figure. In the figure, a user's transmission on a frequency band occupies less than the available total frequency bandwidth. In general, a user may be selected for transmission on multiple bands within a frame, and on different bands in different frame intervals, as long as only one fragment from the codeword is placed in each over-the-air frame. When fragmentation is not used, for users 1 and 3, the codewords generated from the IP packets are too large to fit within the available resources in a single frame in the frequency bands allocated to them; for user 2, although each of the codewords fit within the allocated resources in a frame interval, 100% utilization of the resources cannot be achieved. However, as seen in the figure, by using physical layer fragmentation scheme, the packets of users 1 and 3 can be transmitted and 100% utilization of the frame resources can be achieved in the frequency band allocated for user 2.

The codeword fragments are transmitted in conjunction with an assignment message, which contains all information about the fragment required by the receiver mobile to receive the transmitted data packet. While the codeword fragments are transmitted over data channel 309, in the preferred embodiment of the present invention the assignment message is transmitted on control channel 310. There are two assignment message strategies. The first is to send one control message per codeword fragment (denoted ‘typical’, below), and the second is to send one control message for a group of fragments. The ‘typical’ strategy allows pre-emption, and allows maximum flexibility in resource allocation. The multi-frame assignment is more effective for frequency selective resource allocation.

TABLE 1
Typical assignment message for physical
layer fragmentation scheme

| Fields | Description |
|---|---|
| UID | User identifier |
| MCS & RU Size | Modulation and coding scheme along with the |
| | size of the RU. There are number of different |
| | ways this information may be encoded. |
| HARQ | HARQ channel index |
| Fragment | Position of the transmitted fragment in |
| position | the physical layer packet |
| Allocated | Location of symbols allocated to the RU |
| resources | in the frame |

The content of a typical assignment message is shown in Table 1. One or more of these fields are present. The assignment message, which is transmitted on control channel 310, must identify the recipient either explicitly with a user ID (UID) or via a mask of the CRC as done in HSDPA. In addition, the MCS & RU information size must be conveyed. Often a HARQ channel ID is included when a receiver supports multiple instants of HARQ. The position of the PHY PDU fragment relative the PHY PDU is required in order to reconstruct the encoded packet and may contain such information as a start and end symbol, and how many symbols are occupied by the PHY PDU, or a fragment number. The location of the symbols allocated to this particular PDU in the frame is indicated by the ‘allocated resources’. All this information may be conveyed in a number of different ways. Tradeoffs can be made to reduce the overhead by quantizing the information and saving system resources at the cost of reduced flexibility.

One example scheme for conveying this information could be based on a method similar to that used in IEEE 802.16 combined with extensions to support physical layer fragmentation. For example, the MCS can be encoded explicitly specifying the modulation level (e.g. QPSK, 16 QAM, 64 QAM, etc) and coding rate (e.g. R=¼, R=⅓, R=½, R=⅔, R=¾, etc). In IEEE 802.16 a Downlink Interval Usage Code (DIUC) and Uplink Interval Usage Code (UIUC) convey the MCS information on both the downlink and uplink, respectively. The RU size can be derived from the allocation size. In IEEE 802.16 the allocation is conveyed by specifying the number of subchannels where each subchannel carries a predetermined number of data symbols. As a result, the receiver can calculate the total number of allocated symbols, and then, based on the MCS, the receiver can calculate the RU information size for an un-fragmented codeword. The size of the RU in bytes, denoted as N, could be computed as: where S is the number of allocated symbols and MCR is the Modulation Coding Rate (in bits/symbol) derived from the MCS.

The IEEE 802.16 signaling can be extended by addition physical fragmentation field that specifies both the fractional size (e.g. ⅛, ½, ¼, etc) and the fragment position. In this case, the fractional size, F_{size}, would be used in combination with the MCS and number of allocated symbols to compute the RU information size as:

$$N = \frac{MCR * S}{8}$$

$$N = \frac{MCR * S}{8 * {F}_{size}}$$

where S and MCR are defined as before. The fractional position, would be used to distinguish between the multiple fragments created. For example, if the fractional size was conveyed as ¼, then fractional position could be conveyed in two bits and would reference a starting point as 0, 1, 2, 3 where 0 would represent the first ¼ of symbols within the codeword, 1 would represent the next quarter of symbols, 2 would represent the third quarter of symbols and 3 would represent the final quarter of symbols. Using a fractional size of ⅛ would divide the codeword into 8 pieces requiring at least 3 bits to reference all the pieces of the codeword. An efficient means for encoding the fractional size and position in 4 bits would be to rely on the leading number of zeros to indicate the fractional size and the remaining number of bits to convey the position. This encoding is tabulated in Table 2.

TABLE 2
Efficient Fragmentation Encoding

| Fragmentation | |
|---|---|
| Field | Description |
| 0001 | No fragmentation |
| 001P | Fragmentation of ½ where P |
| | indicates the position, 0 or 1 |
| 01PP | Fragmentation of ¼ where PP |
| | indicates the position 0 to 3 |
| 1PPP | Fragmentation of ⅛ where PPP |
| | indicated the position of 0-7 |

Depending on the fractional size, the granularity may not be enough to occupy the remaining space in a frame. In that case, it is only possible to substantially fill the frame.

An alternate and more general way of extending the IEEE 802.16 signaling would be to separately encode a fractional size as both a denominator and numerator. The dominator of the fractional size, denoted as fractional base (F_{base}), would convey the granularity of the physical layer fragmentation (e.g. ½, ¼, ⅛) and the numerator would convey the size of the current allocation in number of slice, denoted as fractional slice count (F_{slice count}). This alternate extended scheme is more flexible and would allow for the mixing of different size fragments for the same codeword. In this case, the transmitter would have to convey three values fragment base, fragment slice count and fragment position. If only one fragment base is used, then this piece of information does not need to be communicated and could be stored in firmware at the receiver. If a fragment base of 16 is used, the all fragment sizes and positions can be conveyed in 8 bits where 4 bits specify the number of slices and the other 4 bits specify the fragment position.

Another example of conveying the assignment information would be to explicitly transmit the RU size instead of the MCS level. In this case the MCR can be derived from RU size and the number of allocated symbols as follows:

$$MCR = \frac{N * 8}{S}$$

The MCR could then be mapped to the MCS by predefined rule in order to differentiate between MCS levels having an equivalent MCR. Similarly the physical layer fragmentation extensions could also be used be applied to this method and the MCR calculation would become:

$$MCR = \frac{{F}_{size} * N * 8}{S}$$

where F_{size} is the fractional size, N is the RU size in bytes and S is the number of allocated symbols.

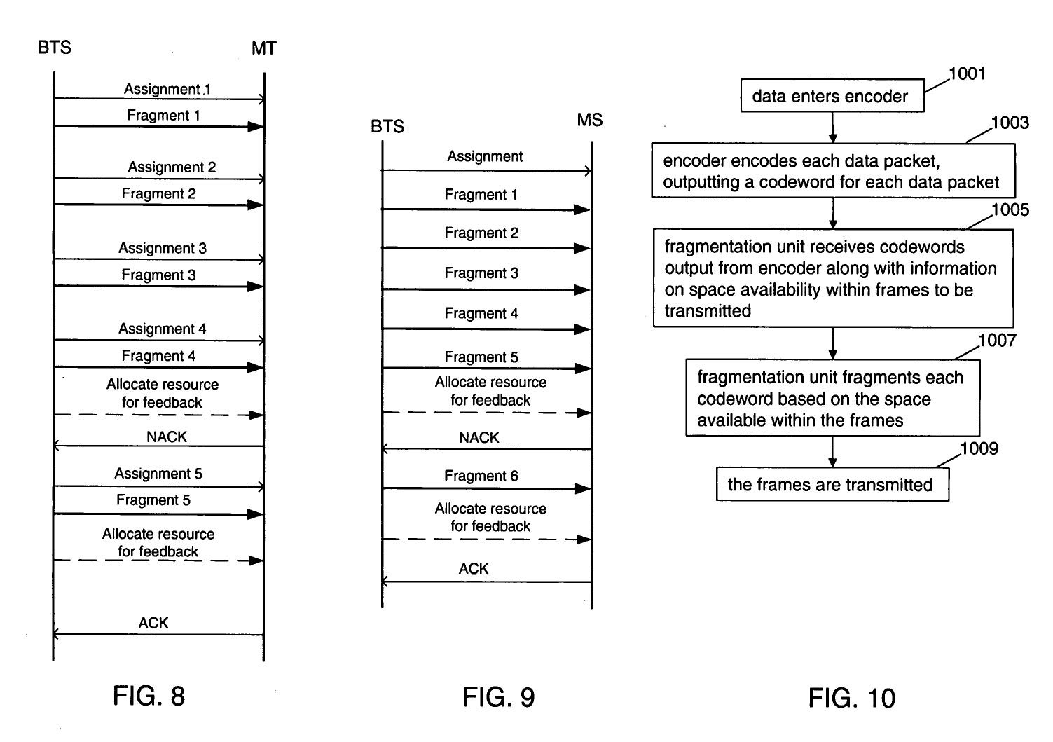

Once the first PHY PDU fragment has been transmitted, the transmitter will continue to send fragments in subsequent frames until the entire encoded RU has been sent or an ACK has been received. Note that these subsequent frames do not need to be consecutive. In fact, the transmission of PHY PDU fragments for a particular packet may be interrupted or pre-empted by higher priority traffic or traffic from users with better channel conditions. The exchanges of messages between the transmitter and the receiver are shown in FIG. 8.

As shown in FIG. 8, an assignment message is transmitted along with each frame. Once the set of fragments transmitted so far contain enough bits (including CRC bits) so that a decoding attempt has a chance of success, transmitter 301 allocates radio resources for the feedback from receiver 302. After receiving a fragment of the physical layer packet, receiver 302 determines if it has received all systematic bits and the CRC. If so, it attempts to decode the received codeword and sends an ACK/NACK depending on the outcome of the decoding. If it has not yet received all of the systematic bits and CRC, receiver 302 may send a NAK, or alternatively may not send any feedback. Optionally, once an ACK is received by transmitter 301, continued transmission of the fragments stops.

For users with very low SNR condition, the transmission of a packet using the physical layer fragmentation scheme may span over a large number of frames (this situation may arise even for high SNR users when only a small subset of the sub- carriers are used, such as in frequency-selective allocation schemes). In such cases, the control channel overheads due to assignment messages can be reduced by using the following methods, denoted as multi-frame assignment scheme:
1. Transmitter 301 splits the packet into several fragments. The size of the fragments is determined by the available radio resources. It is often efficient to size the first fragment based on the available resources in the initial frame, and then size the subsequent fragments to fill the entire frame until the final fragment contains the remainder of the PHY PDU which is likely less than a complete frame.
2. Transmitter 301 transmits an assignment message of the format shown in Table 2. In general the information is the same as in Table 1. However, now the allocated resources not only cover the current frame but subsequent frames. Of course there are many ways to optimize the encoding of the PHY fragment.
3. Transmitter 301 transmits the successive fragments in successive frames in the frame location described in the assignment message.

The message flow describing this scheme is shown in FIG. 9.

TABLE 3
Assignment message for multi-frame assignment scheme.

| Fields | Description |
|---|---|
| UID | User identifier |
| MCS & RU Size | Modulation and coding scheme along with the |
| | size of the RU. There are number of different |
| | ways this information may be encoded. |
| HARQ | HARQ channel index |
| Fragment | Position of the transmitted fragment in |
| position | the codeword |
| Allocated | Location of symbols allocated to the RU in |
| resources | the frame current and subsequent frames |

The physical layer fragmentation technique should also be applied to the retransmission of RUs which could not be successfully decoded by the receiver. The exact technique of retransmission depends on the ARQ protocol. For HARQ with Chase combining technique, the retransmission scheme with physical layer fragmentation works similar to the initial transmission. For the Incremental Redundancy (IR) technique of HARQ, retransmissions contain additional redundancy bits (which can be smaller than the initial transmission) that reduce the effective code rate of the cumulative transmissions. When the mother code rate is reached, retransmitted bits wraps around to the systematic bits. The physical layer fragmentation scheme can also be applied to the IR retransmissions. After receiving fragments of retransmissions, the receiver should apply early termination procedure.

FIG. 10 is a flow chart showing operation of the transmitter of FIG. 3. The logic flow begins at step 1001 where a data packet (more specifically an RU enters channel encoder 303. As discussed above, the RU preferably comprises large data packets. In the preferred embodiment of the present invention the data packets comprise IP packets substantially equal to a MTU size. At step 1003 encoder encodes each RU, outputting a codeword for each RU. More particularly, convolutional turbo encoders or low density parity check encoders can be used

At step 1005 fragmentation unit 304 receives codewords output from encoder 303 along with information on space availability within frames for the users scheduled for transmission. More particularly, transmitter 305 provides fragmentation unit 304 with an available space (e.g., available symbols) for of the frame to be transmitted that is in the process of being scheduled. At step 1007 fragmentation unit 304 fragments each codeword based on the space available within the current frame to be transmitted and outputs the fragments to transmission circuitry 305. As discussed above, the fragment sizes are chosen so that they can optimally fit into frames being transmitted by transmitter 305. Since transmitter 305 may be transmitting other information within the frames (e.g., overhead traffic, data destined to other users, . . . , etc.), each frame may have a varying amount of space available for transmitting the codeword. Thus, each fragment may occupy a varying number of symbols. Optionally, it is possible to have steps 1005 and 1007 jointly determined so that fragmentation and scheduling are jointly optimized.

The logic flow then continues to step 1009 where the frames and control information are transmitted by circuitry 305. As discussed above, control information is provided so that reception circuitry 306 can properly extract the fragmented codeword. Additionally, the codeword may be transmitted to the user utilizing H-ARQ. When H-ARQ is being utilized, a retransmission scheme with physical layer fragmentation works similar to the initial transmission. For the Incremental Redundancy (IR) technique of HARQ, retransmissions contain additional redundancy bits (which can be smaller than the initial transmission) that reduce the effective code rate of the cumulative transmissions. When the mother code rate is reached, retransmitted bits wraps around to the systematic bits.

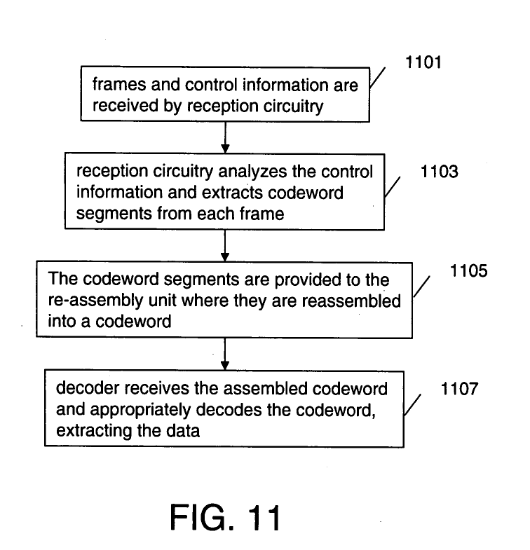

FIG. 11 is a flow chart showing operation of the receiver of FIG. 3. The logic flow begins at step 1101 where a plurality of frames and control information are received by reception circuitry 306. At step 1103 reception circuitry 306 analyzes the control information and extracts codeword fragments from each frame. The codeword segments are provided to re-assembly unit 307 where they are reassembled into a codeword (step 1105). Finally, at step 1107 channel decoder 309 receives the assembled codeword and appropriately decodes the codeword, extracting the reliability unit and ultimately the data (e.g., an IP packet).

When H-ARQ is being utilized, decoder 308 may request additional retransmission of a particular frame. Thus, information may be passed to transmission circuitry 306 that will cause transmission circuitry 306 to transmit a request for retransmission. In a similar manner, if enough information is obtained to allow for successful decoding of a codeword, information may be passed to transmission circuitry 306 which will cause transmitter 301 to cease transmitting the codeword.

While the invention has been particularly shown and described with reference to a particular embodiment, it will be understood by those skilled in the art that various changes in form and details may be made therein without departing from the spirit and scope of the invention. In particular, while this invention was described on the downlink, it is also applicable on the uplink. This invention is also intended to work with variable frame duration. It is intended that such changes come within the scope of the following claims.

1. A method for transmitting data, the method comprising the steps of:
receiving a reliability unit comprising a data packet;
encoding the reliability unit to produce a codeword;
fragmenting the codeword into a plurality of fragments;
placing the plurality of fragments into a plurality of over-the-air frames; and
transmitting the plurality of over-the-air frames.

2. The method of claim 1 wherein the step of receiving the reliability unit comprises the step of receiving an IP packet.

3. The method of claim 1 wherein the step of receiving the reliability unit comprises the step of receiving an IP packet at substantially a maximum transmission unit (MTU) size.

4. The method of claim 1 wherein the step of encoding comprises the step of channel encoding.

5. The method of claim 1 wherein the step of fragmenting the codeword into the plurality of fragments comprises the step of fragmenting the codeword into a plurality of fragments of differing sizes.

6. The method of claim 5 wherein the step of fragmenting the codeword into the plurality of differing size fragments comprises the step of fragmenting the codeword into the plurality of differing size fragments wherein the size of a fragment is based on an amount of space in an over-the-air frame.

7. The method of claim 1 wherein the step of placing the plurality of fragments into a plurality of over-the-air frames comprises the step of placing the plurality of fragments into a plurality of over-the-air frames such that one fragment is placed in each over-the-air frame.

8. The method of claim 1 further comprising the step of transmitting control information identifying a fragment position within a codeword.

9. The method of claim 8 wherein the step of transmitting the control information comprises the step of transmitting a control message per fragment identifying information needed by a receiver to receive the reliability unit.

10. The method of claim 9 wherein the step of transmitting the control information comprises the step of transmitting a control message per fragment identifying at least one or more of a user identifier, a modulation and coding scheme, a HARQ channel index, a position of the fragment, and a location of symbols allocated the fragment in the frame.

11. The method of claim 8 wherein the step of transmitting the control information comprises the step of transmitting a control message for a group of fragments identifying information needed by a receiver to receive the reliability unit.

12. The method of claim 11 wherein the step of transmitting the control information comprises the step of transmitting a control message identifying at least one or more of a user identifier, a modulation and coding scheme, a HARQ channel index, a position of the fragment, and a location of symbols allocated the fragment in the frame.

13. The method of claim 1 wherein the step of placing the plurality of fragments into a plurality of over-the-air frames comprises the step of placing the plurality of fragments onto the plurality of over-the-air frames such that the fragments are placed on a frequency band that is less than an available total frequency bandwidth..

14. The method of claim 1 further comprising the steps of:
receiving an early termination acknowledgment; and
ceasing transmission of the plurality of over-the-air frames based on the received early termination acknowledgment.

15. A method for receiving data, the method comprising the steps of:
receiving a plurality of over-the-air frames;
extracting a plurality of codeword fragments from the over-the-air frames;
assembling the plurality of codeword fragments into a codeword; and
decoding the codeword to produce a reliability unit.

16. The method of claim 16 further comprising the step of:
extracting a data packet from the reliability unit.

17. The method of claim 17 wherein the step of extracting the data packet comprises the step of extracting an IP packet at substantially a maximum transmission unit (MTU) size.

18. The method of claim 16 wherein the step of decoding comprises the step of channel decoding.

19. An apparatus comprising:
an encoder receiving a reliability unit comprising a data packet and encoding the reliability unit to produce a codeword;
a fragmentation unit fragmenting the codeword unit into a plurality of fragments; and
a transmitter placing the plurality of fragments into a plurality of over-the-air frames and transmitting the plurality of over-the-air frames.

20. An apparatus comprising:
a receiver receiving a plurality of over-the-air frames and extracting a plurality of codeword fragments from the over-the-air frames;
a re-assembly unit assembling the plurality of codeword fragments into a codeword; and
a decoder decoding the codeword to produce a reliability unit.
